(19) United States
(12) Patent Application Publication
(10) Pub. No.: US 2009/0224495 A1
(43) Pub. Date: Sep. 10, 2009

(54) Collapsible shopping caddy

(76) Inventor: Janice S. Anderson, San Diego, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 12/358,460

(22) Filed: Jan. 23, 2009

Related U.S. Application Data
(63) Continuation-in-part of application No. 29/304,735, filed on Mar. 6, 2008.

(51) Int. Cl. B62B 3/02

(52) U.S. Cl. 280/47.26

(57) ABSTRACT

A three-wheeled, lightweight shopping caddy that collapses into a compact package easily storable in the trunk of an automobile. The caddy has a very small footprint and narrow profile for easy maneuverability in crowded spaces. A slanted triangular support surface having number of hooks and pockets provide convenient attachment points and storage spaces for bags and packages.

### PRIOR APPLICATION

This is a continuation-in-part of U.S. Design patent application Ser. No. 29/304,735 filed Mar. 6, 2008.

### FIELD OF THE INVENTION

This invention relates to carts and caddies intended to carry shopping bags and small packages during a shopping expedition through a mall or department store. More specifically, the invention relates to narrow profile and small footprint caddies that can be conveniently collapsed for storage in the confined space of an automobile trunk or backseat.

### BACKGROUND

The prior art offers a plethora of shopping carriers. Most of them, as exemplified by the device disclosed in U.S. Pat. No. 6,003,894 (Maher). This device features a box-like container into which packages are piled up on top of one another. This can result in the crushing and damaging of items placed in the bottom of the container.

U.S. Pat. No. 5,678,842 (Hook, et al.), and U.S. Pat. No. 7,188,859 (Hardin, et al.) disclose shopping bag carriers in the general form of a coatrack or tree with branches from which bags can be conveniently hung. Although those devices offer a more practical alternative to the box-type carriers, they either have a relatively large footprint that make it difficult to navigate through a shopping crowd, or exhibit lack of lateral stability.

The instant invention results from an attempt to palliate the short comings of the prior art shopping caddies and to achieve a reasonable compromise between bulkiness and stability in wheeled shopping aids.

### SUMMARY

It is an object of the invention to provide an improved collapsible shopping cart over known prior carts. These and other objects are achieved by a lightweight, collapsible, three-wheeled shopping caddy which uses a sheet of pliable material tautly spread between obliquely oriented posts that converge downwardly toward a single front swiveling caster.

In some embodiments that sheet is attached to a number of bag suspending hooks and package receiving pockets. In some embodiments folding legs resting on wheels project backwardly from median portions of the posts. In some embodiments triangular fabric gussets are tensioned between the legs and the lower sections of the posts. In some embodiments the gussets shield a pocket secured to the back lower portion of the sheet and intended to hold a purse or other valuable items against lateral reach of an unscrupulous person.

Some embodiments of the caddy comprise a caster resting on a ground surface; a yoke mounting said caster; first and second substantially symmetrical shafts oriented at an acute angle to said surface and having lower extremities secured to said yoke; a pair of foldable legs, each having an upper end portion rotatively secured to a median section of one of said shafts, a median portion, and a lower portion resting on said surface; first and second tensioning members, each attached on one end to a median portion of one of said legs and an opposite end attached to a median portion of one of said shafts; spreading member having a given length and opposite ends secured to said shafts; and, a plurality of cargo holding members held between the said shafts.

In some embodiments the caddy further comprises first and second triangular gussets, each being spread between one of said shafts and one of said legs.

In some embodiments each of said tensioning elements comprises first and second bars each having an inward end rotatively attached to the other bar, said first bar having an outward end rotatively attached to one of said shafts and said second bar having an outward end rotatively attached to one of said legs, wherein said spreading member comprises first and second rods each having an inward end rotatively attached to the other rod and outward end attached to one of said shafts.

In some embodiments the caddy further comprises means for stabilizing said tensioning members and said spreading member into linear positions.

In some embodiments each of said lower portions of the legs comprises a wheel.

In some embodiments the caster comprises a swiveling shank attached to said yoke.

In some embodiments the caddy further comprises a sheet of pliable material tautly spread between said shafts by said spreading member, and having a front and a back face, wherein said cargo holding members comprise at least one hook having a shank secured to said sheet; said cargo holding members comprise at least one pocket secured to said sheet; and said pocket is secured to said back face between said gussets.

In some embodiments the lower extremities of the shafts are secured to the yoke at point separated by a distance lesser than said given length; whereby said shafts are aligned along converging lines: and said lower extremities are rotatively secured to said yoke about axes substantially perpendicular to said spread sheet; whereby, said shafts can be rotated toward each other with a folding movement of said spreading member.

In some embodiments the acute angle of the shaft ranges from 45-70°.

In some embodiments the legs are rotatively secured to said posts about axes substantially parallel to said spread sheet; wherein said legs may be rotated toward said posts by a folding movement of said tensioning members.

In some embodiments the cargo holding members comprise a cup-holder secured to one of said shafts.

In some embodiments the caddy further comprises a pair of handles mounted at upper extremities of said shafts.

In some embodiments the caddy further comprises a sheet of pliable material tautly spread between said shafts, and wherein said cargo holding elements comprises a plurality of hooks having shanks secured to said sheet.

In some embodiments the caddy further comprises a sheet of pliable material tautly spread between said shafts, and wherein said cargo holding elements comprise at least one pocket secured to said sheet, wherein said sheet comprises lengths of reinforcing strips securing said shanks to said sheets.

In some embodiments the yoke comprises an horizontal cargo supporting ledge projecting forwardly from said sheet.

In some embodiments the caddy is collapsible into an elongated package, said legs being folded alongside said shafts and said shafts being brought alongside each other.

### BRIEF DESCRIPTION OF THE DRAWINGS

FIG. 1 is a front perspective view of a shopping caddy according to the invention;

FIG. 2 is a back plan view thereof;

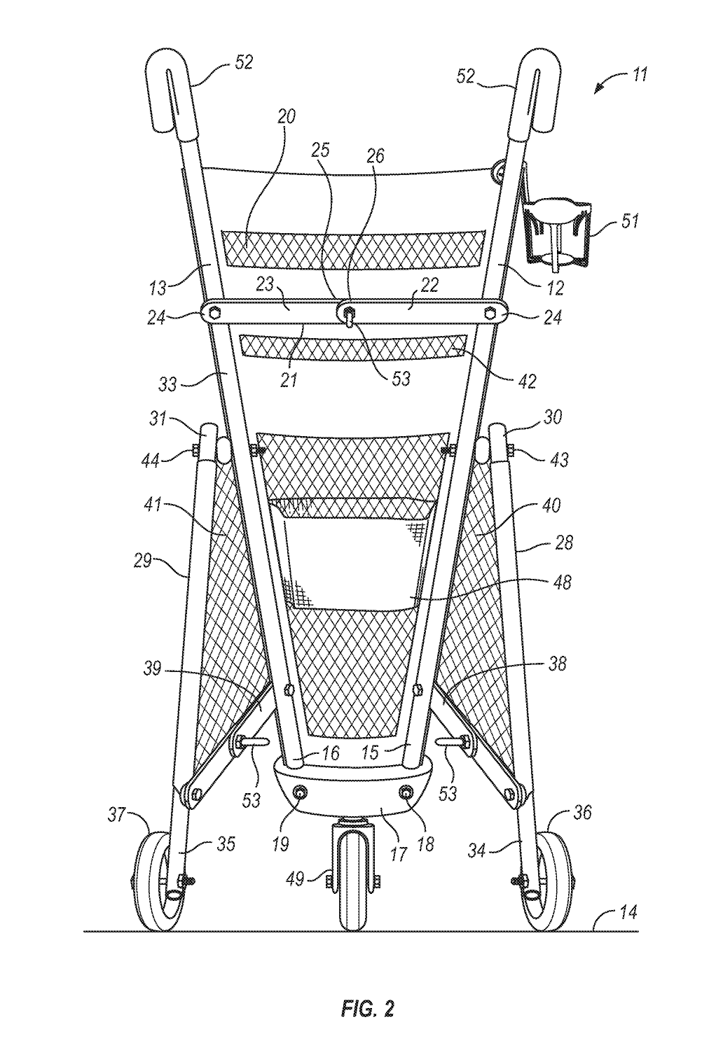

FIG. 3 is a perspective view of the caddy in its folded configuration: and

FIG. 4 is a perspective view of the spreading member locking mechanism.

### DESCRIPTION OF THE EXEMPLARY EMBODIMENTS

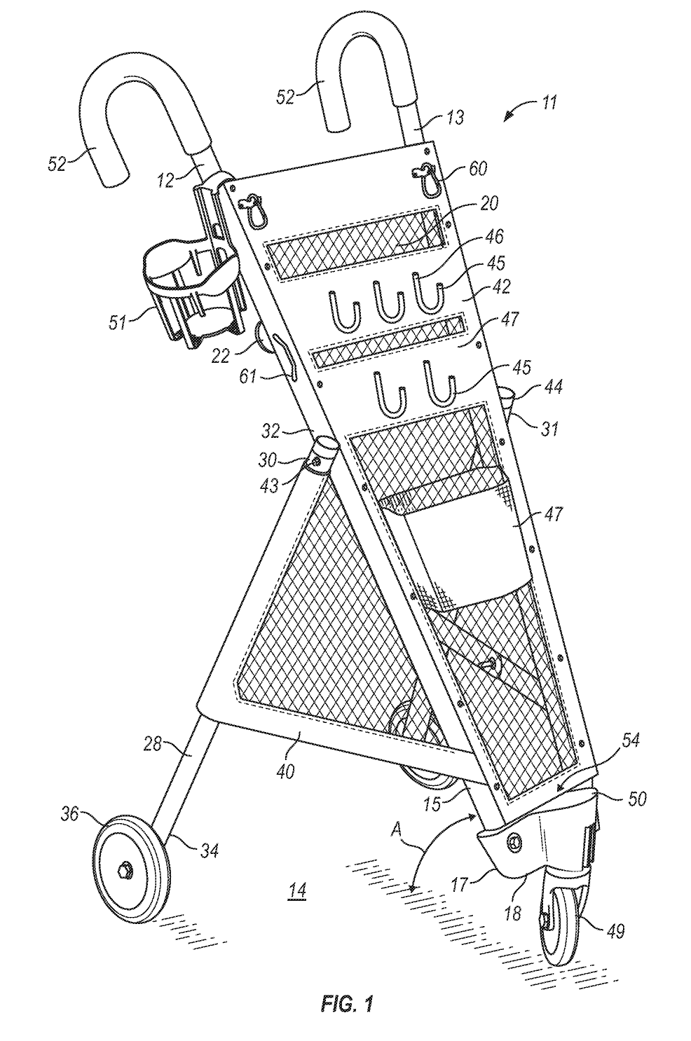

Referring now to the drawing, there is shown a shopping caddy 11 in a fully deployed configuration in FIGS. 1 & 2.

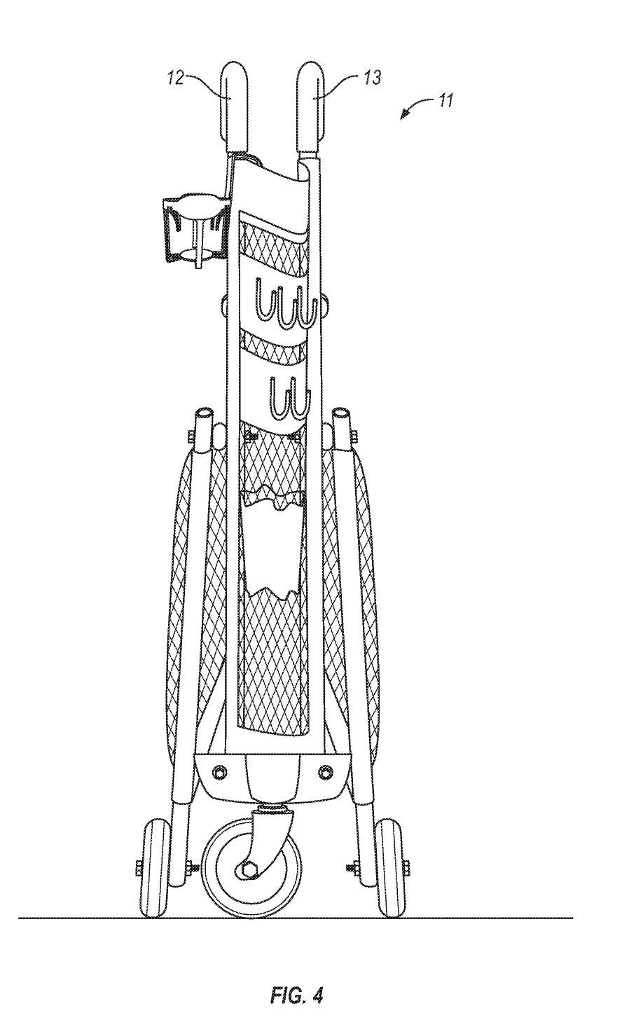

The caddy comprises a right shaft 12 and a left shaft 13 or arms preferably made of tubing stock. The shafts are substantially symmetrical and oriented at an acute angle A with the ground surface 14 of approximately 45-70° and preferably in typical applications approximately 60°. The lower extremities 15, 16 of the shafts are rotatively connected to a yoke 17 by pins 18, 19 substantially perpendicular to the plane defined by the main portions of the shafts. This plane is partially occupied by a sheet 20 of a pliable material, preferably a Nylon netting spread tautly therebetween. The shafts are kept along downwardly converging lines by a spreading member 21 that maintains the tightness of the sheet 20. The spreading member comprises a first rod 22 and a second rod 23 each having their outward ends 24 rotatively attached to the backside of one of the shafts and their inward ends 25,26 rotatively attached together, whereby the spreading member can be scissor-folded to relieve the tension applied to the sheet 20 and bring the two shafts close together as illustrated in FIG. 4. The distance between the yoke pins 18, 19 is substantially lesser than the length of the spreading member 21 in its extended linear position.

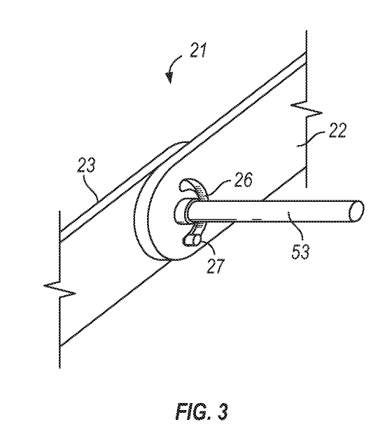

It should be understood that other equivalent substitutes for the spreading member could be used such as a unitary releasable rod. As shown in FIG. 3, the spreading member 21 is stabilized in its extended position by a mechanism consisting of a 180° arcuate slot 26 in the inward end of one of the rods centered on the articulation axis and, a pin 27 projecting from the inward end of the other rod into said slot.

It should be understood that other equivalent stabilizing mechanisms could alternately be used such as a section of one rod projecting slightly over the other rod or any other obvious approach well known to people skilled in the mechanical arts.

A pair of foldable legs 28, 29 each having an upper end portion 30, 31 rotatively secured to a median portion of one of the shafts and a lower portion 34, 35 resting on the ground surface 14 by ways of a pair of wheels 36, 37. Each leg is stabilized in its deployed position by a tensioning member 38, 39 operating substantially similar to the spreading member 21. A pair of triangular gussets 40, 41 made of pliable material preferably similar to the type used in the earlier described sheet 20 extend between the shafts and the legs. The gussets are dimensioned to be outwardly tensioned by the deployed tensioning members 38, 39.

The legs 28, 29 are rotatively secured to the outer sides of the post by pins 43, 44 aligned along an axis substantially parallel to the plane of the spread sheet 20. Alternately, the legs can be locked in a number of angular positions relative to the posts in order to raise or lower the rear end of the cart and thus adjust the slant of the platform for better control of different loads.

A plurality of bag suspending hooks 45 have their shanks secured to reinforcing strips 42 of fabric stitched to the spreaded sheet 20. A number of clasps 60 can be located at various positions, and a number of anchoring cleats 61 can be mounted along the lateral surfaces of the posts to hang bags therefrom. A number of pockets 47, 48 are formed in the front and back faces of the spread sheet 20. Theses pockets are shaped and dimensioned to carry purses, packages, documents or other articles.

It should be noted that the gussets in combination with the spread sheet provide a protective enclosure for items of greater importance such as a wallet or purse stored in the rear pocket 48. The gussets also protect the user's legs from boxes spilling off the top of the caddy. The gussets also prevent bags dangling on the sides of the caddy from interfering with free movement of the user's legs.

The yoke 17 supports a front caster 49 having a swiveling shank for ease of maneuvering the caddy. The top surface of the yoke forms a ledge 50 having a top surface substantially perpendicular to the plane of the spread sheet 20. The ledge and sheet intersect each other at a substantially orthogonal crook 54 that can intimately nest and securely support a cargo container such as a box having a quadrangular outer surface.

A cup-holder 51 is conveniently affixed to the upper portion of one of the shafts 12. The shafts are terminated at their upper end by curved handles 52 which can telescopingly engage the shafts for adjustability purposes.

Folding the spreading member and tensioning members causes the caddy to assume a compact oblong package configuration illustrated in FIG. 3 with the legs folded against the shafts, and the shafts brought alongside each other.

The articulation pins 53 at the centers of the spreading and tensioning members project slightly beyond the articulation to form convenient handles that facilitate the folding process.

In this way the caddy can be made to be lightweight, collapsible, multifunctional and adapted to be particularly useful to persons of limited strength engaged in shopping trips to places such as shopping malls where numerous stores are visited and products are purchased before the shopper has had a chance to place the purchased items in a secure place such as the trunk of an automobile. Numerous boxes and bags can be stacked or secured to the caddy in a stable manner.

In order for the caddy to be used by persons of limited strength it is made from lightweight materials such as extruded aluminum tubing, and nylon mesh webbing. The caddy is made to be collapsible so that it can easily fit into the trunk of an automobile and minimize disturbance of the other contents of the trunk. The caddy provides a reduced lateral profile to allow for easy movement in the tight confines of store aisles.

The generally triangular shape of the spread sheet, its angled orientation, and the center located front wheel and the spaced apart rear wheels provide greater functionality and stability while maintaining a reduced weight. The spread sheet forms a slanted flat support surface which gets wider as it extends upwardly and rearwardly from the yoke. This arrangement provides enhanced lateral stability to boxes supported higher on the caddy by providing more surface area contact. Boxes dropping a greater distance pose a greater risk of damage to the contents or whatever they land on. In addition, the bulky portion of hanging bags can hang near the narrower, front portion of the caddy to reduce the lateral footprint.

While the exemplary embodiments of the invention have been described, modifications can be made and other embodiments may be devised without departing from the spirit of the invention and the scope of the appended claims.

What is claimed is:

1. A caddy which comprises a caster resting on a ground surface;
a yoke mounting said caster;
first and second substantially symmetrical shafts oriented at an acute angle to said surface and having lower extremities secured to said yoke;
a pair of foldable legs, each having an upper end portion rotatively secured to a median section of one of said shafts, a median portion, and a lower portion resting on said surface;
first and second tensioning members, each attached on one end to a median portion of one of said legs and an opposite end attached a median portion of one of said shafts;
a spreading member having a given length and opposite ends secured to said shafts; and
a plurality of cargo holding members held between the said shafts.

2. The caddy of claim 1, which further comprises first and second triangular gussets, each being spread between one of said shafts and one of said legs.

3. The caddy of claim 1, wherein each of said tensioning elements comprises first and second bars each having an inward end rotatively attached to the other bar, said first bar having an outward end rotatively attached to one of said shafts and said second bar having an outward end rotatively attached to one of said legs.

4. The caddy of claim 3, wherein said spreading member comprises first and second rods each having an inward end rotatively attached to the other rod and outward end attached to one of said shafts.

5. The caddy of claim 4, which further comprises means for stabilizing said tensioning members and said spreading member into linear positions.

6. The caddy of claim 1, wherein each of said lower portions comprises a wheel.

7. The caddy of claim 1, wherein said caster comprises a swiveling shank attached to said yoke.

8. The caddy of claim 2, which further comprises a sheet of pliable material tautly spread between said shafts by said spreading member, and having a front and a back face.

9. The caddy of claim 8, wherein said cargo holding members comprise at least one hook having a shank secured to said sheet.

10. The caddy of claim 8, wherein said cargo holding members comprise at least one pocket secured to said sheet.

11. The caddy of claim 10, wherein said pocket is secured to said back face between said gussets.

12. The caddy of claim 1, wherein said lower extremities are secured to said yoke at point separated by a distance lesser than said given length;
whereby said shafts are aligned along converging lines.

13. The caddy of claim 12, wherein said lower extremities are rotatively secured to said yoke about axes substantially perpendicular to said spread sheet;
whereby, said shafts can be rotated toward each other with a folding movement of said spreading member.

14. The caddy of claim 1, wherein said acute angle ranges from 45-70°.

15. The caddy of claim 1, wherein said legs are rotatively secured to said posts about axes substantially parallel to said spread sheet;
wherein said legs may be rotated toward said posts by a folding movement of said tensioning members.

16. The caddy of claim 1, wherein said cargo holding members comprises a cup-holder secured to one of said shafts.

17. The caddy of claim 1, which further comprises a pair of handles mounted at upper extremities of said shafts.

18. The caddy of claim 1, which further comprises a sheet of pliable material tautly spread between said shafts, and wherein said cargo holding elements comprises a plurality of hooks having shanks secured to said sheet.

19. The caddy claim 1, which further comprises a sheet of pliable material tautly spread between said shafts, and wherein said cargo holding elements comprise at least one pocket secured to said sheet.

20. The caddy of claim 18, wherein said sheet comprises lengths of reinforcing strips securing said shanks to said sheets.

21. The caddy of claim 1, wherein said yoke comprises an horizontal cargo supporting ledge projecting forwardly from said sheet.

22. The caddy of claim 1, collapsible into an elongated package, said legs being folded alongside said shafts and said shafts being brought alongside each other.
